(19) United States
(12) Patent Application Publication
(10) Pub. No.: US 2018/0266808 A1
(43) Pub. Date: Sep. 20, 2018

(54) SYSTEMS AND METHODS FOR TESTING OPTICAL FIBER

(71) Applicant: PHOTON KINETICS, INC., Beaverton, OR (US)

(72) Inventors: Casey Shaar, Portland, OR (US); Carl W. Clawson, Hillsboro, OR (US)

(21) Appl. No.: 15/901,872

(22) Filed: Feb. 21, 2018

Related U.S. Application Data
(60) Provisional application No. 62/474,018, filed on Mar. 20, 2017.

(51) Int. Cl. G01B 11/02; G01M 11/00

(52) U.S. Cl. CPC G01B 11/02; G01M 11/3109

(57) ABSTRACT

Various embodiments of an apparatus for measuring a length of an optical fiber are provided. In one embodiment, a method of testing an optical fiber comprises measuring a length of the optical fiber based on a time of flight of an optical pulse launched through the optical fiber from a first optical time domain reflectometer (OTDR) system and received by a second OTDR system; and controlling the first and the second OTDR systems to characterize the optical fiber based on the measured length of the optical fiber. In this way, defects and other physical characteristics of an optical fiber may be accurately determined.

### CROSS REFERENCE TO RELATED APPLICATIONS

The present application claims priority to U.S. Provisional Patent Application No. 62/474,018, entitled “Systems and Methods for Testing Optical Fiber,” filed Mar. 20, 2017, the entire contents of which are hereby incorporated by reference in their entirety for all purposes.

### FIELD OF INVENTION

Embodiments of the subject matter disclosed herein relate to testing optical fiber, and more particularly, to measuring a length of an optical fiber.

### BACKGROUND

Optical time domain reflectometers (OTDR) are used for testing fiber optic cables. An OTDR typically includes a laser diode that introduces pulses of optical energy into an optical fiber at a proximal end of the fiber under test, and a photodiode which generates a current signal that depends on the power with which optical energy is emitted from the fiber at its proximal end in response to the input pulse.

Optical energy is emitted from the fiber at its proximal end due to Fresnel reflections and backscattering. Fresnel reflections occur due to abrupt changes in the refractive index of the medium through which the light pulse is propagating. Typically, such changes occur at connections between lengths of fiber and at breaks in the fiber. Backscatter is Rayleigh scattering returning in the reverse direction relative to the introduced pulse direction. Rayleigh scattering occurs due to interaction between the photons of the optical pulses introduced into the fiber and the molecules of the fiber. Rayleigh scattering results in an unavoidable loss in power as an optical pulse travels along the fiber, and therefore the power level of backscattered light establishes the maximum distance that a pulse can travel along the fiber without suffering an unacceptable loss in power. The power level of backscattered light also provides diagnostic information, in that at locations where the fiber is under stress and might therefore be susceptible to damage, the stress induces additional optical attenuation which produces a detectable change in the rate the backscattered signal decreases.

### BRIEF DESCRIPTION

Various embodiments of an apparatus for measuring a length of an optical fiber are provided. In one embodiment, a method of testing an optical fiber comprises measuring a length of the optical fiber based on a time of flight of an optical pulse launched through the optical fiber from a first optical time domain reflectometer (OTDR) system and received by a second OTDR system; and controlling the first and the second OTDR systems to characterize the optical fiber based on the measured length of the optical fiber. In this way, the length of the fiber can be determined while employing one or both OTDRs to additionally accurately determine its defects and other physical characteristics.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a block diagram illustrating an example system for measuring a length of an optical fiber according to an embodiment.

FIG. 2 shows a high-level flow chart illustrating an example method for measuring a length of an optical fiber according to an embodiment.

FIG. 3 shows a graph illustrating an example method for measuring a time-of-flight of an optical pulse according to an embodiment.

FIG. 4 shows a graph illustrating another example method for measuring a time-of-flight of an optical pulse according to an embodiment.

FIG. 5 shows a graph illustrating another example method for measuring a time-of-flight of an optical pulse according to an embodiment.

### DETAILED DESCRIPTION

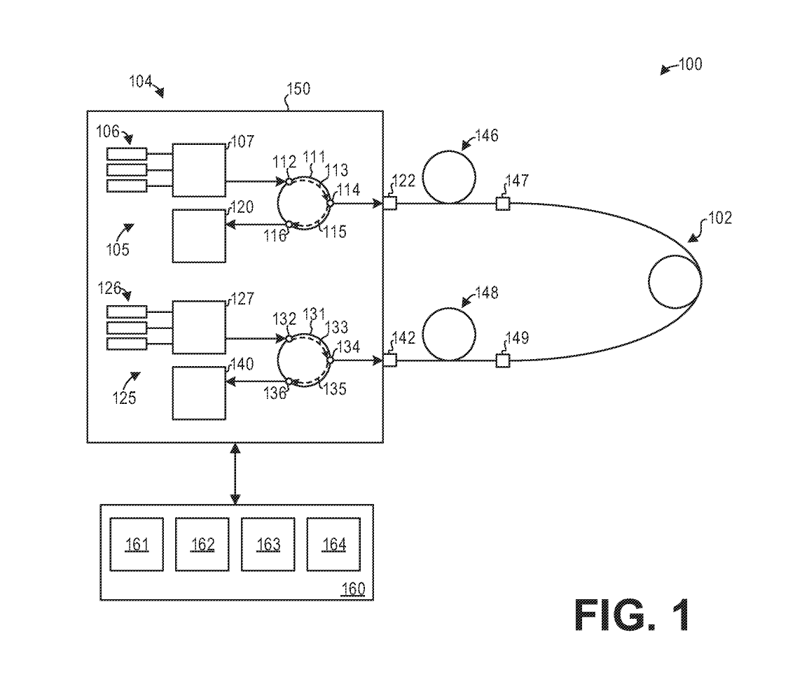

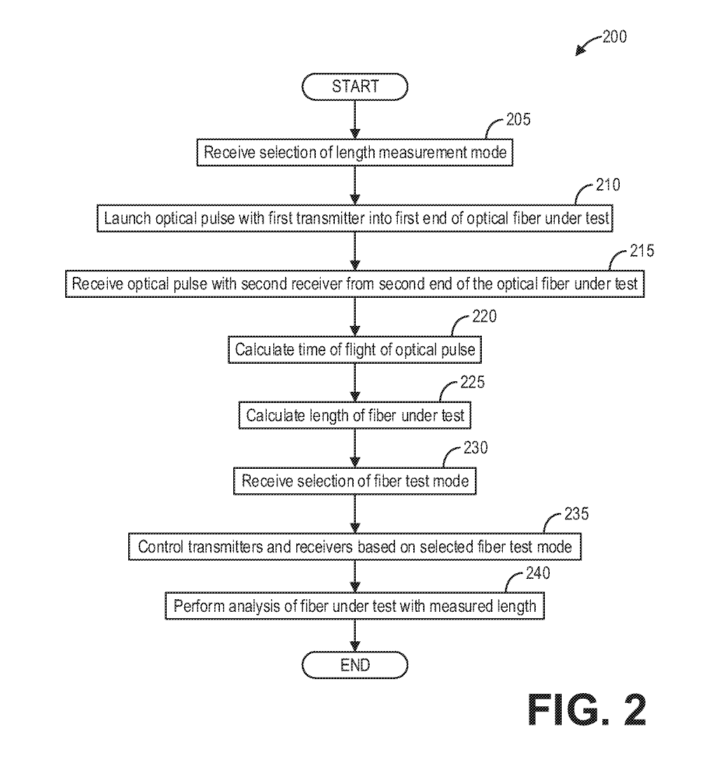

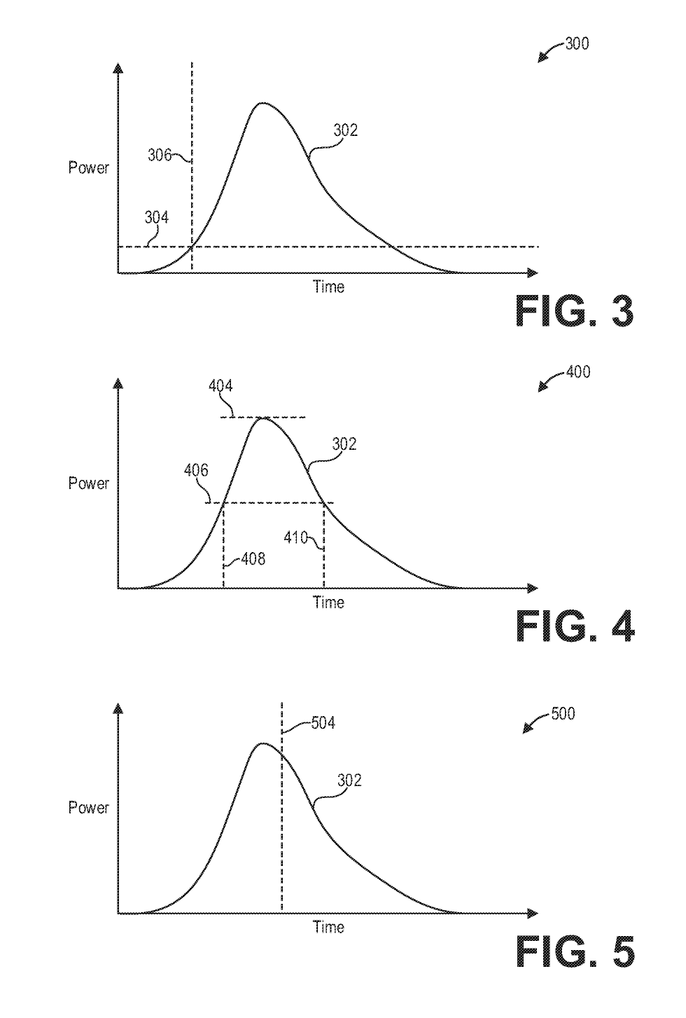

The following description relates to various systems and methods for testing an optical fiber. In particular, methods and systems are provided for measuring the length of an optical fiber. A system for measuring the length of an optical fiber, such as the system depicted in FIG. 1, may include two independent OTDR systems. An optical pulse may be launched from a first OTDR system into the optical fiber and received by a second OTDR system. The length may be calculated based on the time of flight of the optical pulse through the optical fiber. A method for measuring the length of an optical fiber, such as the method depicted in FIG. 2, may further include controlling the OTDR systems to characterize the attenuation of the optical fiber in both directions more accurately as the length of the optical fiber is known. Various techniques for measuring the time of flight of the optical pulse through the optical fiber are depicted in FIGS. 3-5.

Turning now to the figures, FIG. 1 shows a block diagram illustrating a system 100 for testing an optical fiber 102 according to an embodiment. In particular, the system 100 includes an OTDR apparatus 104 configured to measure a length of an optical test fiber 102, i.e., an optical fiber arranged within the system 100 for the purpose of evaluation and/or characterization.

Optical test fiber 102, herein also referred to simply as optical fiber 102 or fiber under test 102, may include a plurality of modes. Accordingly, optical fiber 102 may comprise a multimode fiber (MMF) or a few-mode fiber (FMF), though it should be appreciated that optical fiber 102 may comprise a single-mode fiber in some examples.

OTDR apparatus 104 includes a first OTDR subsystem 105 and a second OTDR subsystem 125 housed within a housing 150. Although a single housing 150 housing both the first OTDR subsystem 105 and the second OTDR subsystem 125 is depicted, it should be appreciated that in some examples, the first OTDR subsystem 105 and the second OTDR subsystem 125 may be housed in separate housings and synchronized via an external synchronization device (not shown). For example, a first structural housing may enclose the first OTDR subsystem 105 and a separate, second structural housing, spaced away and distinct from the first structural housing, may enclose the second OTDR subsystem 125. The first OTDR subsystem 105 includes a first plurality of transmitters 106 while the second OTDR subsystem 125 includes a second plurality of transmitters 126. In some examples, the transmitters may comprise lasers. For example, each laser of the first and second plurality of lasers 106 and 126 may comprise fixed-wavelength lasers, or in some examples may comprise tunable lasers capable of generating light at various wavelengths. Most generally, each laser of the first plurality of lasers 106 and the second plurality of lasers 126 may be tuned to generate optical signals at specific wavelengths or a range of wavelengths such that together the first plurality of lasers 106 and the second plurality of lasers 126 may cover the complete wavelength range of interest.

The first OTDR subsystem 105 may further include a switching device 107 to select one of the first plurality of lasers 106 for operation, as only one of the first plurality of lasers 106 may be operated at a time. In some examples the switching device 107 may comprise a switch, while in other examples the switching device 107 may comprise a wavelength division multiplexer or a 50% coupler configured to combine the output of the plurality of lasers 106.

The first OTDR subsystem 105 may further include a first three-port directional coupler 111 (herein ‘combiner’), which may comprise a 50% fused coupler, an optical circulator, or other devices. First combiner 111 may include a first combiner port 112 optically coupled to the output of the switching device 107. First combiner 111 may further include a second combiner port 114 optically coupled to a first port 122 of the OTDR apparatus 104. First combiner 111 may further include a third combiner port 116 optically coupled to a first receiver 120 of the first OTDR subsystem 105. Light entering the first combiner port 112 is guided to the second combiner port 114 via the combiner channel 113, and output from the second combiner port 114 to the first port 122. Light entering the second combiner port 114 from the first port 122 is guided to the third combiner port 116 via the combiner channel 115, and output from the third combiner port 116 to the receiver 120.

Similarly, the second OTDR subsystem 125 may include a switching device 127 configured to select one of the second plurality of lasers 126 for operation. The second OTDR subsystem 125 may also include a second combiner 131 which includes a first combiner port 132, a second combiner port 134, and a third combiner port 136. Similar to the first combiner 111, the first combiner port 132 is optically coupled to the switching device 127 and receives output from one of the lasers 126. Light entering the first combiner port 132 is guided to the second combiner port 134 via a combiner channel 133 and output to a second port 142 of the OTDR apparatus 104. Light entering the second combiner port 134 from the second port 142 is guided to the third combiner port 136 via a combiner channel 135, and output to the second receiver 140 of the second OTDR subsystem 125.

The first receiver 120 and the second receiver 140 may comprise photodetectors configured to convert received optical signals into electrical signals for processing. Although not shown, the OTDR apparatus 104 may include electronics, laser pulsing circuits, receiver trans-impedance amplifiers, digitizers, acquisition logic (DSP, gate array), and waveform memory. Each OTDR subsystem may include its own trans-impedance amplifier and its own laser pulsing circuitry which is triggered by common acquisition logic. The acquisition logic may be connected, typically through a standard bus (e.g., PCI or USB), to a computing device 160.

System 100 may further include a computing device 160 communicatively coupled to the OTDR apparatus 104. Computing device 160 may include a processor 161, a non-transitory memory 162 storing executable instructions and recorded data received from the OTDR apparatus 104, a display device 163 configured to display a graphical user interface and/or visualizations of data relating to the OTDR apparatus 104, and a user interface 164 configured to receive user input. Computing device 160 may be configured to receive data recorded by the detectors 120 and 140 and further to perform analyses of said data. Additionally, the computing device 160 may be configured to provide control signals to the OTDR apparatus 104 to control one or more components of the OTDR apparatus 104, including but not limited to the first plurality of lasers 106, the switching device 107, the receiver 120, the second plurality of lasers 126, the switching device 127, and the receiver 140. The computing device 160 may be configured to provide different sets of commands to the OTDR apparatus 104 depending on a selected operating mode of the OTDR apparatus 104.

It should be appreciated that while the computing device 160 is depicted in FIG. 1 as a separate apparatus communicatively coupled to and positioned external to the OTDR apparatus 104, in some examples the computing device 160 and the OTDR apparatus 104 may be integrated into a single apparatus.

As depicted, the system 100 may further include a launch fiber 146 coupled to the first port 122 and a receive fiber 148 coupled to the second port 142 of the OTDR apparatus 104. Both the launch fiber 146 and the receive fiber 148 may comprise buffer fibers measuring 1 to 1.5 kilometers in length and may comprise a similar type of optical fiber to the fiber under test 102. The buffer fibers 146 and 148 ameliorate reflective events that occur near the OTDR ports 122 and 142. The buffer fibers 146 and 148 further enable the determination of the mode field diameter of the fiber under test 102 if the mode field diameter at any wavelength of interest is known. The fiber under test 102 may be coupled to the buffer fibers 146 and 148 via temporary coupling means 147 and 149, respectively, while the buffer fibers 146 and 148 may be permanently coupled to the first and second ports 122 and 142, respectively.

FIG. 2 shows a high-level flow chart illustrating an example method 200 for measuring a length of an optical fiber according to an embodiment. Method 200 will be described with regard to the systems and components depicted in FIG. 1, though it should be understood that the method may be implemented with other systems and components without departing from the scope of the present disclosure. Method 200 may be implemented as executable instructions in the non-transitory memory 162 of the computing device 160, and may be executed by the processor 161 of the computing device 160.

Method 200 begins at 205. At 205, method 200 includes receiving a selection of a length measurement mode. For example, a user may select the length measurement mode via user interface 164 to initiate a length measurement of an optical fiber coupled to the OTDR apparatus 104.

To begin the length measurement of the fiber under test, at 210, method 200 includes launching an optical pulse with a first transmitter into a first end of the optical fiber under test. For example, launching an optical pulse with a first transmitter may comprise controlling one of the lasers of the first plurality of lasers 106 of the first OTDR subsystem 105 to generate an optical pulse that is directed via the switching device 107 and the combiner 111 into the first end of the fiber under test 102 (e.g., the end of the optical fiber 102 coupled to the launch cable 146 via coupling means 147).

At 215, method 200 include receiving the optical pulse with a second receiver from the second end of the optical fiber under test. For example, the optical pulse may be received by the second receiver 140 of the second OTDR subsystem 125 from the second end of the fiber under test 102 (e.g., the end of the optical fiber 102 coupled to the receive cable 148 via coupling means 149).

After receiving the optical pulse, method 200 continues to 220. At 220, method 200 includes calculating the time of flight of the optical pulse through the fiber under test. To illustrate how method 200 may calculate the time of flight of the optical pulse through the fiber under test, FIGS. 3-5 each show a graph illustrating a plot 302 of an optical pulse in terms of power over time.

For example, FIG. 3 shows a graph 300 illustrating a fixed threshold technique for identifying when the optical pulse reaches the receiver. For a fixed threshold 304 above the signal baseline, the fixed threshold location 306 comprises the location where the waveform crosses the threshold. The total time of flight of the optical pulse may therefore comprise the time elapsing between the launching of the optical pulse and the detection of the waveform crossing the threshold 304 at the location 306. Thus, in one example, method 200 calculates the time of flight by measuring the time elapsing between the launching of the optical pulse and the detection of the waveform crossing the threshold 304 at the temporal location 306.

As another example, FIG. 4 shows a graph 400 illustrating a half-power edge technique for identifying when the optical pulse depicted by plot 302 reaches the receiver. The optical pulse reaches half-power 406, which is half of the maximum power 404, at the locations 408 and 410. The location may be taken as the leading half-power location 408 or the trailing half-power location 410, or in some examples may be taken as an average of the two locations 408 and 410. Thus, in another example, method 200 calculates the time of flight by using the half-power edge technique.

As yet another example, FIG. 5 shows a graph 500 illustrating a centroid technique for identifying the temporal location at which the optical pulse depicted by plot 302 reaches the receiver. The centroid 504 of the optical pulse may be calculated by discrete integration. For example, if the optical pulse is recorded as P(t), the centroid t_{c} may be calculated using the equation:

$${t}_{c} = \frac{\int t \cdot P ( t ) dt}{\int P ( t ) dt} ,$$

where t refers to time. The calculated centroid 504 may thus be used to determine the total time of flight. Thus, in yet another example, method 200 calculates the time of flight by using the centroid technique.

Once the total time of flight is calculated, the time of flight of the optical pulse through the fiber under test 102 may be obtained by subtracting the known time of flight of the optical pulse through the testing components, namely the optical path from the laser of the plurality of lasers 106 to the coupling means 147 as well as the optical path from the coupling means 149 to the receiver 140. The remaining time therefore corresponds to the time of flight of the optical pulse through the fiber under test 102.

At 225, method 200 includes calculating the length of the fiber under test 102. The length of the fiber under test 102 may be obtained, as a non-limiting example, by multiplying the time of flight through the fiber under test 102 by the speed of the optical pulse through the fiber under test 102. The speed of the optical pulse may be accurately determined if the refractive index of the optical fiber is known, though it should be appreciated that for the purpose of improving the determination of reflectances, defects, and inhomogeneities in the fiber under test 102, the time of flight is sufficient without converting it to a physical length.

Once the length of the fiber under test is calculated, the measured length may be stored at least temporarily in non-transitory memory 162 of the computing device 160 and/or output to display device 163 for display.

Continuing at 230, method 200 includes receiving a selection of a fiber test mode, for example via the user interface 164. The fiber test mode may comprise a typical test suitable for an OTDR, such as measuring attenuation in an optical fiber and detecting the location of defects. At 235, method 200 includes controlling the transmitters and receivers based on the selected fiber test mode to test the fiber under test 102. As a non-limiting example, each of the OTDR subsystems 105 and 125 may be controlled to obtain a trace signature of the fiber under test 102 in each direction. At 240, method 200 includes performing an analysis of the fiber under test 102 based on the measured length. With the length of the fiber under test 102 known, the location of the splices at 147 and 149 may be accurately determined such that the analysis of the fiber under test 102 may not erroneously treat said splices as defects in the fiber under test 102 itself. Method 200 may then end.

In one embodiment, a method of testing an optical fiber comprises: measuring a length of the optical fiber based on a time of flight of an optical pulse launched through the optical fiber from a first optical time domain reflectometer (OTDR) system and received by a second OTDR system; and controlling the first and the second OTDR systems to characterize the optical fiber based on the measured length of the optical fiber.

In a first example of the method, the method further comprises measuring the time of flight of the optical pulse by detecting when a receiver of the second OTDR system measures a waveform crossing a power threshold. In a second example of the method optionally including the first example, the power threshold is above a signal baseline. In a third example of the method optionally including one or more of the first and second examples, the power threshold is equal to half of a maximum power of the optical pulse. In a fourth example of the method optionally including one or more of the first through third examples, the method further comprises measuring the time of flight of the optical pulse by detecting when a centroid of the optical pulse reaches a receiver of the second OTDR system. In a fifth example of the method optionally including one or more of the first through fourth examples, the first and second OTDR systems are housed in a single housing, and the optical fiber is coupled to the first and second OTDR systems via a first port and a second port fixed to the housing. In a sixth example of the method optionally including one or more of the first through fifth examples, the optical fiber is coupled to the first and the second OTDR systems via respective buffer fibers, and the method further comprises identifying a location of couplings between the optical fiber and the respective buffer fibers based on the measured length of the optical fiber. In a seventh example of the method optionally including one or more of the first through sixth examples, the method further comprises receiving a selection of a fiber test mode. In an eighth example of the method optionally including one or more of the first through seventh examples, controlling the first and the second OTDR systems to characterize the optical fiber based on the measured length of the optical fiber comprises controlling the first and the second OTDR systems to test the optical fiber according to the fiber test mode. In a ninth example of the method optionally including one or more of the first through eighth examples, controlling the first and the second OTDR systems to characterize the optical fiber based on the measured length of the optical fiber further comprises performing an analysis of results from testing the optical fiber, wherein the analysis is limited to the measured length of the optical fiber.

In another embodiment, an apparatus for testing an optical fiber comprises a first optical time domain reflectometer (OTDR) subsystem comprising a first light source, a first receiver, and a first combiner optically coupled to the first light source and the first receiver, and a second OTDR subsystem comprising a second light source, a second receiver, and a second combiner optically coupled to the second light source and the second receiver, wherein a length of the optical fiber is measured by measuring a time of flight of an optical pulse launched, with the first light source, into a first end of the optical fiber and received, with the second receiver, from a second end of the optical fiber.

In a first example of the apparatus, the length of the optical fiber is calculated by a processor communicatively coupled to at least the second receiver and configured with instructions in non-transitory memory that when executed cause the processor to calculate the length of the optical fiber based on the time of flight. In a second example of the apparatus optionally including the first example, the processor is further configured with instructions in non-transitory memory that when executed cause the processor to subtract a known time of flight of the optical pulse through testing components of the apparatus from the time of flight to obtain a time of flight of the optical pulse through the optical fiber. In a third example of the apparatus optionally including one or more of the first and second examples, calculating the length of the optical fiber based on the time of flight comprises calculating the length of the optical fiber based on the time of flight of the optical pulse through the optical fiber. In a fourth example of the apparatus optionally including one or more of the first through third examples, the processor is further configured with instructions in non-transitory memory that when executed cause the processor to perform an analysis of the optical fiber, wherein the analysis is limited to the length of the optical fiber.

In some examples of the apparatus, the first OTDR subsystem and the second OTDR subsystem are housed in a same housing. In other examples of the apparatus, the first OTDR subsystem and the second OTDR subsystem may be housed in separate housings.

In yet another embodiment, a system for testing an optical fiber comprises a first optical time domain reflectometer (OTDR) subsystem comprising a first light source, a first receiver, and a first combiner optically coupled to the first light source and the first receiver, a second OTDR subsystem comprising a second light source, a second receiver, and a second combiner optically coupled to the second light source and the second receiver, the first OTDR subsystem and the second OTDR subsystem housed in a same housing, and a processor communicatively coupled to the first and the second OTDR subsystems and configured with instructions in non-transitory memory that when executed cause the processor to: calculate a length of the optical fiber based on a time of flight of an optical pulse launched, with the first light source, into a first end of the optical fiber and received, with the second receiver, from a second end of the optical fiber; and control the first and the second OTDR subsystems to measure attenuation of the optical fiber based on the calculated length of the optical fiber.

In a first example of the system, the system further comprises a first buffer fiber optically coupled to the first combiner and a second buffer fiber optically coupled to the second combiner, wherein the first end of the optical fiber is coupled to the first buffer fiber and the second end of the optical fiber is coupled to the second buffer fiber. In a second example of the system optionally including the first example, the processor is further configured with instructions in non-transitory memory that when executed cause the processor to: measure a total time of flight of the optical pulse; and subtract, from the total time of flight of the optical pulse, a first known time of flight of the optical pulse from the first light source through the first buffer fiber and a second known time of flight of the optical pulse from the second buffer fiber to the second receiver to obtain the time of flight. In a third example of the system optionally including one or more of the first and second examples, the processor is further configured with instructions in non-transitory memory that when executed cause the processor to measure the total time of flight of the optical pulse by detecting when the second receiver measures a waveform crossing a power threshold. In a fourth example of the system optionally including one or more of the first through third examples, the processor is further configured with instructions in non-transitory memory that when executed cause the processor to measure the total time of flight of the optical pulse by detecting when a centroid of the optical pulse reaches the second receiver.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. Are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method of testing an optical fiber, comprising:
measuring a length of the optical fiber based on a time of flight of an optical pulse launched through the optical fiber from a first optical time domain reflectometer (OTDR) system and received by a second OTDR system; and
controlling the first and the second OTDR systems to characterize the optical fiber based on the measured length of the optical fiber.

2. The method of claim 1, further comprising measuring the time of flight of the optical pulse by detecting when a receiver of the second OTDR system measures a waveform crossing a power threshold.

3. The method of claim 2, wherein the power threshold is above a signal baseline.

4. The method of claim 3, wherein the power threshold is equal to half of a maximum power of the optical pulse.

5. The method of claim 1, further comprising measuring the time of flight of the optical pulse by detecting when a centroid of the optical pulse reaches a receiver of the second OTDR system.

6. The method of claim 1, wherein the first and second OTDR systems are housed in a single housing, and wherein the optical fiber is coupled to the first and second OTDR systems via a first port and a second port fixed to the housing.

7. The method of claim 1, wherein the optical fiber is coupled to the first and the second OTDR systems via respective buffer fibers, and further comprising identifying a location of couplings between the optical fiber and the respective buffer fibers based on the measured length of the optical fiber.

8. The method of claim 1, further comprising receiving a selection of a fiber test mode.

9. The method of claim 8, wherein controlling the first and the second OTDR systems to characterize the optical fiber based on the measured length of the optical fiber comprises controlling the first and the second OTDR systems to test the optical fiber according to the fiber test mode.

10. The method of claim 9, wherein controlling the first and the second OTDR systems to characterize the optical fiber based on the measured length of the optical fiber further comprises performing an analysis of results from testing the optical fiber, wherein the analysis is limited to the measured length of the optical fiber.

11. An apparatus for testing an optical fiber, comprising:
a first optical time domain reflectometer (OTDR) subsystem comprising a first light source, a first receiver, and a first combiner optically coupled to the first light source and the first receiver; and
a second OTDR subsystem comprising a second light source, a second receiver, and a second combiner optically coupled to the second light source and the second receiver;
wherein a length of the optical fiber is measured by measuring a time of flight of an optical pulse launched, with the first light source, into a first end of the optical fiber and received, with the second receiver, from a second end of the optical fiber.

12. The apparatus of claim 11, wherein the length of the optical fiber is calculated by a processor communicatively coupled to at least the second receiver and the first light source and configured with instructions in non-transitory memory that when executed cause the processor to calculate the length of the optical fiber based on the time of flight.

13. The apparatus of claim 12, wherein the processor is further configured with instructions in non-transitory memory that when executed cause the processor to subtract a known time of flight of the optical pulse through testing components of the apparatus from the time of flight to obtain a time of flight of the optical pulse through the optical fiber.

14. The apparatus of claim 13, wherein calculating the length of the optical fiber based on the time of flight comprises calculating the length of the optical fiber based on the time of flight of the optical pulse through the optical fiber.

15. The apparatus of claim 12, wherein the processor is further configured with instructions in non-transitory memory that when executed cause the processor to perform an analysis of the optical fiber, wherein the analysis is limited to the length of the optical fiber.

16. A system for testing an optical fiber, comprising:
a first optical time domain reflectometer (OTDR) subsystem comprising a first light source, a first receiver, and a first combiner optically coupled to the first light source and the first receiver;
a second OTDR subsystem comprising a second light source, a second receiver, and a second combiner optically coupled to the second light source and the second receiver, the first OTDR subsystem and the second OTDR subsystem housed in a same housing; and
a processor communicatively coupled to the first and the second OTDR subsystems and configured with instructions in non-transitory memory that when executed cause the processor to:
calculate a length of the optical fiber based on a time of flight of an optical pulse launched, with the first light source, into a first end of the optical fiber and received, with the second receiver, from a second end of the optical fiber; and
control the first and the second OTDR subsystems to measure attenuation of the optical fiber based on the calculated length of the optical fiber.

17. The system of claim 16, further comprising a first buffer fiber optically coupled to the first combiner and a second buffer fiber optically coupled to the second combiner, wherein the first end of the optical fiber is coupled to the first buffer fiber and the second end of the optical fiber is coupled to the second buffer fiber.

18. The system of claim 17, wherein the processor is further configured with instructions in non-transitory memory that when executed cause the processor to:
measure a total time of flight of the optical pulse; and
subtract, from the total time of flight of the optical pulse, a first known time of flight of the optical pulse from the first light source through the first buffer fiber and a second known time of flight of the optical pulse from the second buffer fiber to the second receiver to obtain the time of flight.

19. The system of claim 18, wherein the processor is further configured with instructions in non-transitory memory that when executed cause the processor to measure the total time of flight of the optical pulse by detecting when the second receiver measures a waveform crossing a power threshold.

20. The system of claim 18, wherein the processor is further configured with instructions in non-transitory memory that when executed cause the processor to measure the total time of flight of the optical pulse by detecting when a centroid of the optical pulse reaches the second receiver.
